(19) United States
(12) Patent Application Publication
(10) Pub. No.: US 2010/0264304 A1
(43) Pub. Date: Oct. 21, 2010

(54) Method for detecting volatile species of high molecular weight

(76) Inventors: Martinez-Lozano Pablo, Madrid (ES); Juan Fernandez de la Mora, New Haven, CT (US)

Correspondence Address: Juan Fernandez de la Mora, 80 Cold Spring Street, New Haven, CT, 06511, US

(21) Appl. No.: 11/732,770

(22) Filed: Apr. 4, 2007

Related U.S. Application Data
(60) Provisional application No. 60/789,549, filed on Apr. 4, 2006.

(51) Int. Cl. H01J 49/04; H01J 49/26

(52) U.S. Cl. 250/282; 252/372

(57) ABSTRACT

Vapors of relatively heavy species having molecular weights in excess of 290 amu have not been previously detected in the gas phase at ambient temperature. A method to detect them is taught here based on the use of a mass spectrometer with an atmospheric pressure source. Ions produced in detectable quantities from such heavy vapors are claimed as a new state of matter.

### CROSS REFERENCE TO RELATED APPLICATION

This application claims the benefit of priority to U.S. Provisional Patent Application No. 60/789,549, filed on Apr. 4, 2006.

### REFERENCES

[1] Willis C M, Church S M, Guest C M, et al. Olfactory detection of human bladder cancer by dogs: proof of principle study. BMJ. 2004; 329:712.
[2] McCulloch, M. et al., Diagnostic Accuracy of Canine Scent Detection in Early- and Late-Stage Lung and Breast Cancers, Integ. Cancer Therapies 5(1); 2006 pp. 1-10
[3] Williams H, Pembroke A., Sniffer dogs in the melanoma clinic? Lancet. 1989; 1:734.
[4] Church J, Williams H. Another sniffer dog for the clinic? Lancet. 2001; 358:930.
[5] Pickel D P, Manucy G P, Walker D B, Hall S B, Walker J C. Evidence for canine olfactory detection of melanoma. Appl. Anim. Behay. Sci. 2004; 89:107-116.
[6] Cheng, W-H and Lee, W-J, Technology Development in Breath Microanalysis for Clinical Diagnosis. J. Lab. Clin. Med. 133, 218-228 (1999)
[7] Phillips, M. et al., Variation in volatile organic compounds in the breath of normal humans. Journal of Chromatography B, 729 (1999) 75-88.
[8] Lindinger, W., Hansel, A., Jordan, A., On-line monitoring of volatile organic compounds at pptv level by means of Proton-Transfer-Reaction Mass Spectrometry (PTR-MS). Medical applications, food control and environmental research. International Journal of Mass Spectrometry and Ion Processes. 173 (1998) 191-241.
[9] Amann, A. et al., Applications of breath gas analysis. International Journal of Mass Spectrometry 239 (2004) 227-233
[10] Lirk, P., Bodrogi, F. and Rieder, J., Medical applications of proton transfer reaction-mass spectrometry: ambient air monitoring and breath analysis. International Journal of Mass Spectrometry 239 (2004) 221-226.
[11] This point is strictly limited to the analysis of volatile species. The remarkable analytical power of APCI-MS in medical diagnosis (either alone, or in combination with liquid chromatography) based on liquid samples is well known (i.e., J. Roboz, Mass Spectrometry in Cancer Research, CRC Press, Boca Raton, Fla., USA). Still, the daunting complexity of blood or urine samples is in sharp contrast with the clean spectra we see for heavy volatiles.
[12] Walker D B, Cavnar P, Taylor J, et al. Canine olfactory thresholds to N-amyl acetate measured naturalistically. Paper presented at: Meeting of the Association for Chemoreception Sciences; April 2003; Sarasota, Fla.
[13] Taylor, A. J., Linforth, R. S. T., Direct mass spectrometry of complex volatile and non-volatile flavour mixtures. International Journal of Mass Spectrometry 223-224 (2003) 179-191
[14] Harvey, B. A., Barra, J., Real time breath and headspace analysis of flavour volatiles. European Journal of Pharmaceutics and Biopharmaceutics 55 (2003) 261-269
[15] The following is a list of the dominant breath peak masses (in amu): 46.04, 70, 73.9, 76, 79.9 (A only), 162 (A dominates), 180.2 (A dominates), 224.2 (A dominates), 231.1, 258.2, 267.2 (B dominates), 270.1, 279.2, 284.3, 312.2, 326.4, 330.1, 332.2, 336.5 340.1, 352.1, 354.2, 388.2, 391.2, 396.3, 408.1, 462, 476 (B only), 536.3, 550.3 (B only). Many more minor breath peaks rise well above the background.
[16] Whitehouse, C. M., Levin, F., Meng, C. K. and Fenn, J. B., Proc. 34th ASMS Conf. on Mass Spectrom. and Allied Topics, Denver, 1986, p. 507.
[17] Fuerstenau, S., Kiselev, P. and Fenn, J. B., ESIMS in the Analysis of Trace Species in Gases. Proceedings of the 47th ASMS Conference on Mass Spectrometry (1999) Dallas Tex.
[18] Fuerstenau, S., Aggregation and Fragmentation in an Electrospray Ion Source. Ph.D. Thesis, Department of Mechanical Engineering, Yale University, 1994.
[19] Wu, C., Siems, W. F. and Hill, H. H. Jr., Secondary Electrospray Ionization Ion Mobility Spectrometry/Mass Spectrometry of Illicit Drugs. Anal. Chem. 2000, 72, 396-403).
[20] Fenn J B, Mann M, Meng C K, Wong S F, Whitehouse C M, Electrospray ionization for mass-spectrometry of large biomolecules. Science 246 (4926): 64-71, 1989
[21] Rogatsky E, Jayatillake H, Goswami G, Tomuta V, Stein D, Sensitive L C MS quantitative analysis of carbohydrates by Cs⁺ attachment, J. Am. Soc. Mass Spectrom. 16, 1805-1811, 2005
[22] Some comparison is of interest here. Reference 2 notes that “Among lung cancer patients and controls, overall sensitivity of canine scent detection compared to biopsy confirmed conventional diagnosis was 0.99”. In contrast Phillips et al.²³ report that “A combination of 22 breath VOCs, predominantly alkanes, alkane derivatives, and benzene derivatives, discriminated between patients with and without lung cancer, regardless of stage (all p<0.0003). For stage 1 lung cancer, the 22 VOCs had 100% sensitivity and 81.3% specificity. Cross-validation of the combination correctly predicted the diagnosis in 71.7% patients with lung cancer and 66.7% of those without lung cancer.”
[23] Phillips M, Gleeson K, Hughes J M, Greenberg J, Cataneo R N, Baker L, et al. Volatile organic compounds in breath as markers of lung cancer: a cross-sectional study. Lancet 1999; 353: 1930-1933
[24] P. Martinez-Lozano Sinués, Ph.D. Thesis. Department of Thermal and Fluid Engineering, University Carlos III of Madrid, 2006. http://hdl.handle.net/10016/655[25] H. Chen, A. Wortmann, W. Zhang, R. Zenobi, Angew. Chem. Int. Ed. 46 (2007) 580-583.

### FIELD OF THE INVENTION

The invention relates to the field of analyzing substances present in a gas at very small concentrations.

### BACKGROUND OF THE INVENTION

The analysis of species existing in a gas by virtue of their finite volatility is of interest in many situations, for instance, for detecting explosives or dangerous substances, in the food and aroma industries, in the identification of incipient symptoms of decomposition in foods, in medical diagnosis based on the composition of bodily fluids or breath, etc. Because the species to be analyzed is in the gas phase, the dominant technique of such analyses has been gas chromatography coupled to mass spectrometry (GC-MS),⁶ where the vapor entering the MS is neutral, and is charged by electron impact within its vacuum system before being analyzed and detected. Electron impact ionization leads to extensive species fragmentation, which provides a complex fingerprint of the vapor analyzed and facilitates its identification as a concrete chemical. However, this method is problematic to detect most large molecules of very small volatility, for which electron fragmentation spectra are generally unavailable. GC-MS is also inappropriate in the analysis of complex mixtures containing many species, when the GC often delivers simultaneously a multitude of peaks to the MS, and the complex pattern of the many fragments from these many peaks becomes undecipherable. GC-MS is also limited by the relatively slow separation in the GC, generally requiring minutes. Finally, GC-MS instruments have relatively modest sensitivity levels, generally in the part per million level (1 ppm=10⁻⁶ atmospheres of partial pressure). Notwithstanding these limitations, GC-MS has achieved a considerable success in many fields, including for instance portable explosive detectors. Another field where GC-MS has made important contributions is in medical diagnosis based on breath analysis, where it has permitted the identification of hundreds of species in human breath, whose relative abundances have in some cases provided useful health indicators. However, the heaviest component reported has been 2-propenoic acid, 2-methyl-,1,2-ethanediylbis(oxy-2,1-ethanediyl) ester (C₁₄H₂₂O₆; 286.3 amu).⁷ It would evidently be more biologically relevant (hence more useful in medical diagnosis) to be able to detect substantially heavier species, not only in breath, but also in other gaseous environments. The same holds in security applications, where certain explosives of high molecular weight are difficult to detect due to the well-known trend of vapor pressure reduction with increasing molecular weight.

A significant advance towards the development of detectors for trace gases was taken in U.S. Pat. No. 4,531,056 by J. Fenn and colleagues through their invention of so called electrospray mass spectrometry (ES-MS; see also reference [20]). This approach was not originally intended to apply to gases, but it led to the development of mass spectrometers with atmospheric pressure ionization sources (API-MS), which are capable of ingesting a substantial flow of ions existing at relatively high pressures, and transmit the ions with fair efficiency to the analyzing region of the mass spectrometers. The quantity of gas sample typically taken by modern versions of such API-MS is of several liter/minute. This greatly exceeds the sample flow rate in MS systems used for GC-MS, and permits in principle greatly increased sensitivities in the analysis of gases with respect to what is possible in GC-MS. A second potential advantage of API-MS is that the ions can be formed at atmospheric pressure, and therefore do not undergo the substantial fragmentation typical of electron impact ionization in a vacuum. As a result, API-MS is capable of distinguishing a much larger number of species simultaneously present in a complex environment. The potential of API-MS for the analysis of trace gases was recognized early on by Fenn and colleagues [16, 17, 18], who demonstrated sensitivity levels in the parts per billion level (ppb=10⁻⁹ atmospheres of partial pressure). Earlier studies had already demonstrated excellent though inferior sensitivities for vapors based on ionizing them at atmospheric pressure and then analyzing them in instrument referred to as ion mobility spectrometers (IMS). Obvious advantages of the method taught by Fenn and colleagues were the much higher sensitivity and resolving power of MS with respect to IMS. Vapor charging is conventionally achieved in such experiments with a separate source of charged species, such as a corona discharge, a radioactive source, etc. Corona charging of vapors had in fact been commercialized by Sciex in their TAGA MS even before the development of electrospray ionization. Fenn and colleagues used a different charging method termed electrospray charging. It consisted on passing the analyte vapors through a region bathed by charged electrospray drops and ions, where the interaction between the charged spray and the vapor leads to ionization of some of the vapor molecules. The same scheme has been subsequently used by Hill and colleagues [19] to ionize vapors for IMS and IMS-MS analysis. These studies have contributed some evidence indicating that this electrospray charging of vapors (termed secondary electrospray ionization by Hill and colleagues) may be advantageous over conventional ionization based on radioactive sources such as Ni-63 sources. The same point has been made also by Fenn and colleagues [17]

Other specialized schemes have been developed independently for volatile analysis involving alternative methods of charging vapors at relatively high pressure. One example is so-called proton transfer reactions (PTR), where the vapors are mixed with solvated protons in a fast flow at reduced pressure. Part per trillion (ppt=10⁻¹² atmospheres of partial pressure) sensitivities have been reported, though only with relatively light species.^{8,9}

Because the potential of API-MS analysis of volatiles is more easily achieved based on commercial API-MS instruments rather than specialized research instruments, we shall focus the subsequent discussion of prior art on the former type. The charging and sampling methods taught by Fenn and colleagues require some detail that will provide the background for our own improvements. The electrospray mass spectrometry method they had introduced in U.S. Pat. No. 4,531,056 involves the use of a counterflow dry gas interposed between the atmospheric pressure inlet of the mass spectrometer and the electrospray source. This counterflow gas is meant to avoid ingestion by the MS of condensible vapors or dust coming from either the electrospray drops or the surrounding atmosphere. As a result, only ions (driven by electric fields against the counterflow) are sucked into the vacuum system of the MS, therefore protecting it form dirt and avoiding condensation of vapors on the transmitted ions. This counterflow gas impinges frontally against the electrospray cloud, which therefore offers excellent contacting area between the dry gas and the charged drops and electrospray ions. This useful feature was used in [16-17] to increase the vapor ionization probablity by feeding controlled quantities of vapor mixed with the counterflow gas, thereby maximizing their contact with the charged cloud and hence the charging probability of the vapor species. Under these conditions they could report sensitivities “for some species at ppb levels or less” [17]. Although quite novel at the time, such sensitivities are unfortunately inadequate to detect explosives such as PETN or RDX, or other vapors with molecular weights in excess of 250 Dalton. Another problem with this approach when used for the analyses of ambient species is that the sample ambient gas is generally not clean, whereby the mass spectrometer would be rapidly contaminated. In conclusion, in spite of the obvious promise of the pioneering work just described [16-19], it has not been pursued to date, probably due to the sensitivity and contamination problems noted. We are in fact unaware of any prior studies demonstrating sensitivities at the ppt level. Consequently, the purpose of the present invention is to teach how to achieve such sensitivities.

Following filing of our provisional patent application, our findings have been partly publicized in the Ph.D. Thesis by Martinez-Lozano [24]. More recently, related findings have been made by the group of Zenobi [26], where a variety of metabolytes were identified in human breath, some with molecular masses exceeding 1000 Dalton. This work, however, confirms the generally held notion of the impossibility to detect high mass or low vapor pressure species based on their very modest volatility. Indeed, the authors of [26] assert that the metabolites they identify in human breath are involatile, and hypothesize that the ions sensed in the mass spectrometer actually came not from vapors but from an aerosol accompanying human breath.

### SUMMARY OF THE INVENTION

The present invention contributes various improvements over prior art taught in [16-17], whose combination enables better than ppt sensitivities to trace vapor species, while also moderating the ingestion of dust, water vapor and other contaminants into the mass spectrometer. Briefly, the vapors to be analyzed are charged by contact with a source of charge, they are then drawn into a mass spectrometer in a fashion such that contaminant ingestion is greatly reduced. Finally, the transmission of ions into the analyzing section of the mass spectrometer is greatly enhanced by the use of so-called ion guides, as discussed for instance in U.S. Pat. No. 4,963,736, or in the related ion funnels of U.S. Pat. No. 6,107,628.

### BRIEF DESCRIPTION OF THE DRAWINGS

FIG. 1 is a front view of the space where charging takes place, upstream of the atmospheric entry port of the API 350 triple quadrupole mass spectrometer commercialized by ABS-Sciex.

FIG. 2 is a lateral view of the charging space illustrated in FIG. 1, with an inset showing its internal details.

FIG. 3 is a mass spectrum of the breath of two subjects obtained with the charger of FIG. 1 coupled to the API 350 MS.

### DETAILED DESCRIPTION OF THE PREFERRED EMBODIMENTS OF THE INVENTION

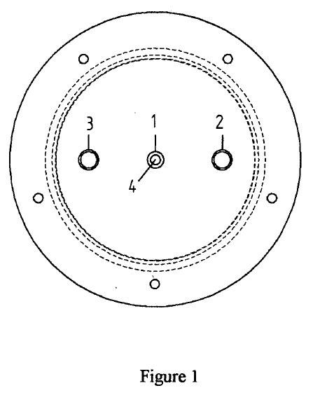

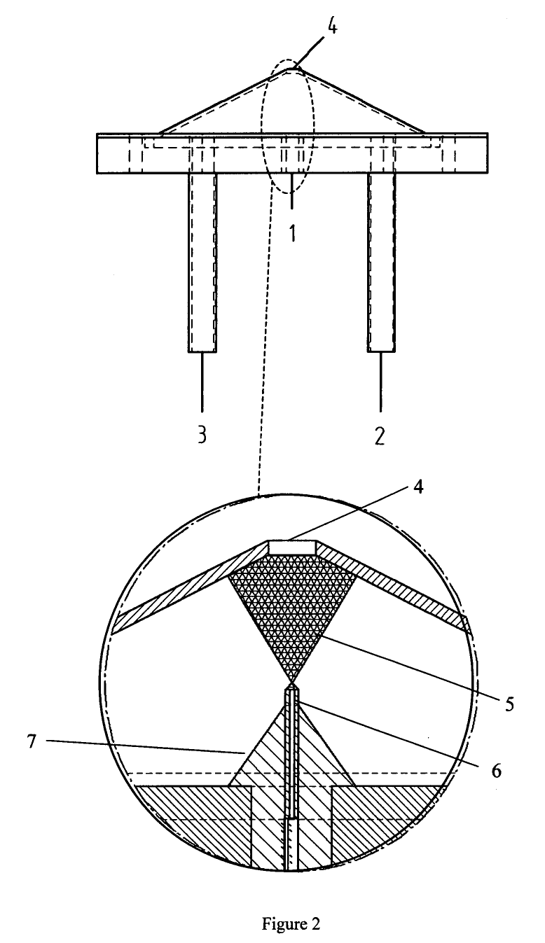

The first essential ingredient of the invention is the charging device, where the vapor species are ionized. In a preferred embodiment this charging is performed by bringing in close contact the sample gas to be ionized and the charged cloud produced by an electrospray. The structure of this charger and its coupling to the API 350 triple quadrupole mass spectrometer commercialized by ABS-Sciex is illustrated in FIGS. 1 and 2. FIG. 1 shows the frontal view of the chamber within which this charging takes place. One sees a central orifice 1 through which the electrospraying unit is introduced in a leak free fashion inside the chamber, an inlet tube 2 through which the sample gas enters into the chamber, and an outlet tube 3 through which any unused excess sample gas exits the chamber and is discarded. These same elements are shown in the lateral view of FIG. 2, where one sees in addition the orifice 4 throuh which clean curtain gas enters into the chamber from the top. This gas flow is a commercial feature of the mass spectrometer, and plays essentially the same role as the counterflow gas previously discussed in relation to U.S. Pat. No. 4,531,056, namely, to avoid entry of vapors and contaminants into the inlet orifice of the mass spectrometer. This inlet orifice to the MS lies above orifice 4 in FIG. 2, and is not detailed because it is a commercial component. The conical piece on which the orifice 4 is drilled is also a commercial component of the MS, called the curtain gas plate. In the preferred embodiment of this invention the curtain plate is installed in the mass spectrometer very much as in conventional MS operation. One component of the charger that is specific to this invention is the plate whose front view is shown in FIG. 1, which rests tightly against the curtain plate and supports components 1, 2, and 3. This plate is metallic and is held at the same potential as the conical curtain plate in the embodiment described, but may more generally include insulating and conducting components charged at various voltages. The insert to FIG. 2 illustrates certain details of the electrospray source, including the charged cloud 5 of ions and drops where the vapor is ionized, and the capillary needle 6 feeding the liquid electrosprayed at the top end of the capillary. The fixture 7 introducing this capillary into the charging chamber is a schematic of a common liquid chromatography fixture used with such capillaries. Not shown are electrical components required to feed a high voltage to the liquid emerging at the upper end of the capillary, nor the mechanical components required to feed the liquid at a controlled rate into the spraying tip. In one application aimed at detecting explosives or dangerous substances in the ambient, atmospheric gas is sampled into the chamber by applying suction through a small pump connected to the exit port 3. The sampled gas then enters into the chamber, gets in contact with the electrospray cloud, some of its vapor components become ionized and are then driven by the prevailing electric field against the curtain gas flow through orifice 4. These ions then proceed into the sampling orifice of the mass spectrometer (not shown). This arrangement therefore achieves vapor ionization similarly as in reference [17], but does so while avoiding contamination of the mass spectrometer from impurities in the ambient gas sampled. In a different application the sampled gas would not come from the ambient, but from the breath of a subject, in which case the exit port 3 would not be connected to a pump, but open to the atmosphere, while the normal exhalation of the subject would push the gas through the inlet port 2 into the chamber. In one such embodiment of the invention intended for breath analysis, the breath of the subject would first go through a cooling or drying device to avoid condensation of water vapor in breath, which is saturated at 37° C. In another embodiment, the same purpose would be attained by keeping the inlet lines and the charging chamber above 37° C.

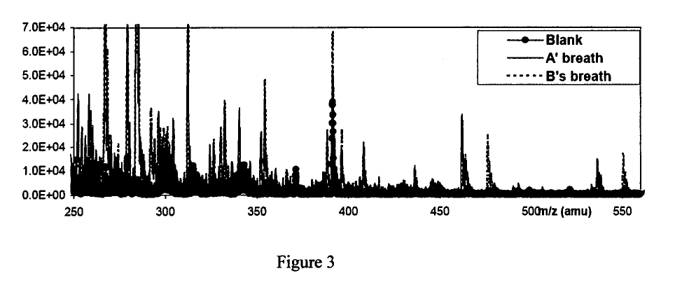

FIG. 3 shows the high mass region of typical mass spectra comparing a blank (from a flow of clean CO₂) with the breath of two healthy subjects. One sees clean characteristic peaks,¹⁵ with signals often orders of magnitude larger than the background (filled circles), at masses going up to 600 amu. These findings are in striking contrast with prior breath analysis literature, where background contributions are comparable to those from breath samples, and the heaviest reported component we have seen is 2-propenoic acid, 2-methyl-,1,2-ethanediylbis(oxy-2,1-ethanediyl) ester (C₁₄H₂₂O₆; 286.3 amu).⁷ Furthermore, the relative differences previously reported in species concentration in breath vs. those in the background air have tended to be fairly small. The medical diagnostic utility of the heavier species identified here is therefore likely to be much greater than in the past, not only due to lack of background interference and clean-cut differences from subject to subject, but also because the specificity of a light species as an indicator of biological activity can be no match to that of a larger and more complex species.

Aside from the medical dignostic applications noted, it is striking that species with masses approaching 600 Dalton would be sufficiently volatile to be sensed in such experiments. This observation is completely new at room temperature, or even at moderately elevated temperature, and justifies by itself the claim of such heavy ions as a new state of matter.

In order to quantify the sensitivity of this vapor charger, it was studied with trioctyl amine vapors (TOA; MW=353.68). Solutions of known concentration of TOA in methanol were electrosprayed into a heated chamber, at a liquid flow rate of ˜2 10⁻⁹ l/s l/s (inferred through Poiseuille's formula for a given driving pressure liquid viscosity and capillary diameter). The very small alcohol drops formed evaporate completely, and the amine vapors released are carried at a known gas phase concentration into the charger region by a controlled flow rate of CO₂. The amine concentration was systematically increased until its protonated ion (m/z=354.3) was detected with a signal/background ratio of 1.8. The threshold was ˜4.2 ppt. This result is particularly interesting in view of the fact that this threshold sensitivity is well below the room temperature vapor pressure of very low volatility explosives such as RDX or PETN, which can be detected by dogs, but have never been previously detected at room temperature by conventional analyzers from the vapor phase. Our combined charger and MS detector can therefore detect such explosives in the ambient.

This invention is of course not restricted to the charging system described, but includes other variants, with different mass spectrometers and chargers. A second embodiment not making use of the curtain gas is based on the system used by mass spectrometers commercialized among others by Finnigan. In these instruments ambient gas is sampled into the MS from a region containing dust, ambient water vapor and drops, as well as vapor from various solvents from the ion sources conventionally used. The ingestion of these contaminants in the vacuum system of the MS is avoided by combining considerable heating in the sampling line (immediately after the inlet orifice to the MS), with a tortuous path of the gas leading from this atmospheric pressure inlet through several sharp bends to a second inlet into a lower pressure reign of the MS. Only ionized species are able to follow this path to be analyzed, while most excess vapors, dust and solid particle residues from dried spray drops sidestep the most delicate regions of the instrument. In one charger-MS embodiment of the invention the charging electrospray cloud would face the MS, either in the open atmosphere, or in an enclosed chamber. In either case, the sample gas to be analyzed would circulate through the spray region, be ionized as in the preferred embodiment, and sampled into the MS inlet orifice. The main difference is the lack of counterflow gas, though still with a clean operation. Many other combinations of chargers and mass spectrometers can be devised by those familiar with the subject matter. For instance, although electrospray charging has some special advantages, other sources of charge can be similarly used to ionize the vapors. Well known examples include radioactive materials, corona discharges, and other source of ionizing radiation (UV light, x rays, etc.).

A second improvement over the prior art taught in reference [17] is essential to achieve the ppt sensitivities obtained by this invention. This feature has followed from well known improvements following Fenn's early electrospray inventions on the efficiency with which atmospheric ions can be transmitted into the vacuum system of a mass spectrometer. Most important among these has been the development of ion guides and their ion funnel variants described for instance in U.S. Pat. Nos. 4,963,736 and 6,107,628. These improvements are now implemented in many commercial mass spectrometers with atmospheric pressure ion sources, including the API 365 Sciex mass spectrometer used in our preferred embodiment, and the Finnigan mass spectrometers of the second embodiment. However mass spectrometers incorporating these improvements have been used exclusively for the analysis of involatile species, generally contained initially in solution. Entirely new of this invention is the utilization of these ion guides (or ion funnels) in combination with an API-MS for the analysis of volatiles. The combination may appear trivial, but the fact that it has not been used long after ion guides have reached maturity, and long after the pioneering work of [17], shows clearly that it is by no means obvious.

An additional aspect of the invention relates to its potential use in medical diagnosis. Such applications have been pursued widely in the past in association to GC-MS, however, with a limited success due to the prior inability to detect the relatively large breath vapors first identified in this invention. The diagnostic relevance of such heavy breath vapors can be gauged from the related success of dogs. Indeed, several recent studies^{1,2} have noted that dogs are able to smell and identify with high confidence the presence of cancerous tissues in patients at an early stage, when other analytical techniques are less reliable. Following initial successes sniffing skin tumors³⁻⁵ and urine,¹ a more general technique based on sniffing a breath sample can now identify lung and breast cancers,² and presumably other internal pathologies releasing volatiles. Because the lung achieves equilibrium between species in the blood and their vapors in the gas, exhaled breath provides non-invasively a continuous window to the biochemical activity within a person. Breath analysis for medical diagnosis has therefore produced a substantial literature.⁶⁻¹⁰ The mystery of what is it that the dogs smell that offers such an accurate fingerprint of malignancy, and why it has escaped conventional breath analysis techniques finds a reasonable answer in our breath studies. Our spectra show that breath vapors exist with molecular masses in excess of 550 amu, greatly widening the sensitivity and specificity of breath analysis.¹¹ We further find that heavy breath vapors are exhaled at concentrations >1 ppt (10⁻¹² atmospheres of vapor pressure), comparable to the sensitivity of dogs,¹² and also to the sensitivity to lighter vapors demonstrated by other MS methods.^{7,13,14} Although still unidentified, the heavy breath vapors found must be closely related to those sensed by dogs, and will therefore be invaluable as health markers, and as sophisticated beacons for metabolic processes. Comparison of the diagnostic specificity of the dog with that of GC-MS breath analyzers relying on relatively light vapors demonstrates that the dog is using information unavailable to these instruments.²² Our data indicate that the dog has the sensitivity needed to detect heavy breath vapors, suggesting the hypothesis that it is in fact using them as key elements in its cancer sniffing process.

There are many other consequences of our findings beyond early cancer detection. Indeed, blood contains numerous species of high biological significance in the mass range from 200 to 600 amu. Their monitoring in breath would be in many cases of great interest, particularly because it can take place in humans, non-invasively, in real time, and for relatively long periods.

What is claimed:

1) A new state of matter consisting of ions produced at detectable concentrations by ionizing at pressures in excess of 1 torr volatile species with masses exceeding 290 Dalton originally carried by a background gas at temperatures below 60° C.

2) A method to detect heavy vapors existing in a gas by virtue of their finite volatility at temperatures below 60° C., consisting of (a) means to ionize said vapors, (b) means to sample said ions into a mass spectrometer with an atmospheric pressure source (c) means to moderate the contaminating effects of contaminants contained within said gas on said mass spectrometer.

3) A method according to claim 2 where said means to moderate said contaminating effects includes the use of counterflow gas

4) A method according to claim 2 where said means to moderate said contaminating effects involves the use of heated lines following the atmospheric pressure inlet to the mass spectrometer

5) A method according to claim 4 where the gas flow downstream from the atmospheric inlet to said mass spectrometer involves one or several sharp bends before reaching the analyzing region of said spectrometer.

6) A method according to claim 2 where said mass spectrometer includes an ion guide.

7) A method according to claim 2 where said mass spectrometer includes an ion funnel.

8) A noninvasive method to quantify the contents of low volatility metabolytes contained in human blood by analyzing the breath of a person according to claim 2.
